(19) United States
(12) Patent Application Publication
(10) Pub. No.: US 2010/0126315 A1
(43) Pub. Date: May 27, 2010

(54) Multiple bit unit

(76) Inventor: Kenneth Kwak, Venice, CA (US)

Correspondence Address: Cislo & Thomas LLP, 1333 2nd Street, Suite #500, Santa Monica, CA, 90401-4110, US

(21) Appl. No.: 12/315,044

(22) Filed: Nov. 25, 2008

(51) Int. Cl. B25B 23/00

(52) U.S. Cl. 81/439

(57) ABSTRACT

A multiple bit device for an automatic drill or screwdriver includes a plurality of bits of different size and functionality, in one compact unit. The multiple bit unit provides a convenient and handy arrangement of bits which allows the user to easily switch to different bits. Additionally, since all of the bits are in one unit, misplacement is less likely, as is with single bit units. Optionally, at least one extender unit which fits over any one of the bits in the multiple bit unit, and supports an additional bit piece may be included.

### BACKGROUND

1. Field of the Invention

The present invention relates to bits for hand held tools such as drills and screwdrivers.

2. Description of the Related Art

Hand tools such as drills and screwdrivers that utilize a variety of bits of different sizes and functionality that fit into the chuck or holding element of the tool, typically require separate storage for containing the bits. Often the bits are carried in a case separate from the tool itself. When switching between different bits, the user has to take one bit out of the tool, place it in the case, and look for another bit which he desires to use. This process is inconvenient, and provides opportunity for misplacement of the bits, especially bits of smaller sizes. Additionally, it distracts from smoothly completing a task that requires the use of a variety of different bits or the use of different drill and screw driver tools.

### SUMMARY

The present invention provides a multiple bit device for an automatic drill or screwdriver which includes a plurality of bits of different size and/or functionality, in one compact unit. The multiple bit unit provides a convenient and handy arrangement of bits which allows the user to easily switch to different bit sizes. Additionally, since all of the bits are in one unit, misplacement is less likely, as is the case with single bit units. According to a preferred embodiment, the device includes a combination of drill and screw driver bits which allows a user to conveniently handle a job requiring both the use of a drill and screw driver. Additionally, the device optionally includes at least one extender unit which fits over any one of the bits in the multiple bit unit, and supports an additional bit piece. Also, the tool could be used without a driver.

### BRIEF DESCRIPTION OF THE DRAWINGS

FIG. 1 illustrates a multiple bit device in accordance with the present invention and a tool into which the device is inserted.

FIG. 2 perspective view of the multiple bit device of FIG. 1.

FIG. 3 is a perspective view of a multiple bit device including drill and screw driver heads.

FIG. 4 is a perspective view of an extender for the multiple bit device of the present invention.

### DETAILED DESCRIPTION OF THE PREFERRED EMBODIMENT

The detailed description set forth below is intended as a description of exemplary embodiments and is not intended to represent the only forms in which the exemplary embodiments may be constructed and/or utilized. The description sets forth the functions and the sequence of steps for constructing and/or operating the exemplary embodiments. However, it is to be understood that the same or equivalent functions and sequences may be accomplished by different exemplary methods are also intended to be encompassed within the spirit and scope of the invention, and within the scope and judgment of the skilled person.

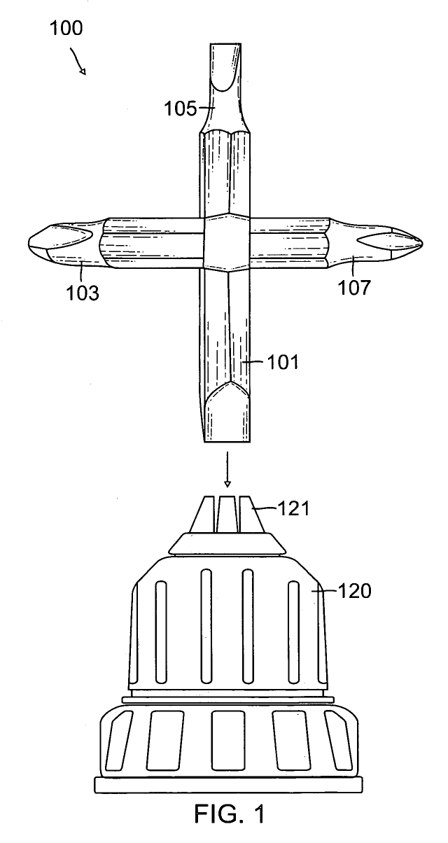

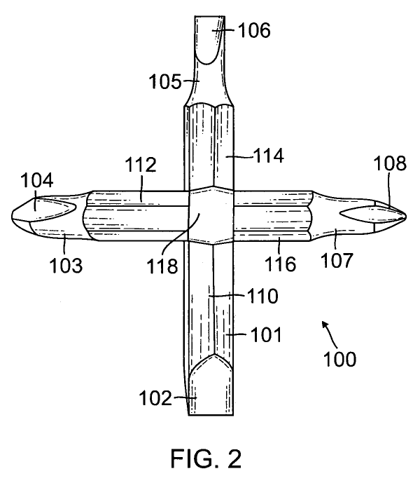

FIGS. 1 and 2 illustrates a multiple bit device 100 for an automatic drill or screwdriver. The device 100 includes four bit pieces 101, 103, 105, and 107 with corresponding heads 102, 104, 106, and 108, in one compact unit. The bit pieces are symmetrically spaced (i.e. 90° apart) forming a cross configuration, as shown in the figures. The device 100 is roughly about 4 inches in diameter, as measured from tip to tip of opposing bit pieces. The bit pieces preferably include bases 110, 112, 114, and 116, which radially extend from a center cross point 118. Each base, or at least a section thereof, preferably has a hexagonal configuration for sliding into a chuck or hexagonal holding element in a standard drill or screwdriver. This provides a frictional hold on the base of one piece, to prevent rotation of the device with respect to the tool, while the head of the opposite piece is used. Each bit piece should be dimensioned to enable the base to insert into the holding element or chuck 121 of the device 120, as shown in FIG. 1. Though the specific dimensions depend on the size and configuration of the tool, for most standard tools, the length from the tip of the bit head to the base should be roughly between ¼ and 1½ inches. Although a hexagonal base is preferred as it is suitable for most standard tools, it should be understood that the device of the present invention is not limited to standard tools. Therefore, any other polygonal configuration of the base is possible (e.g. octagonal, pentagonal, etc.), as long as it conforms to the holding element of the tool, and provides for a frictional hold of the device. Other methods of holding the device in place within the tool may be apparent to one skilled in the art.

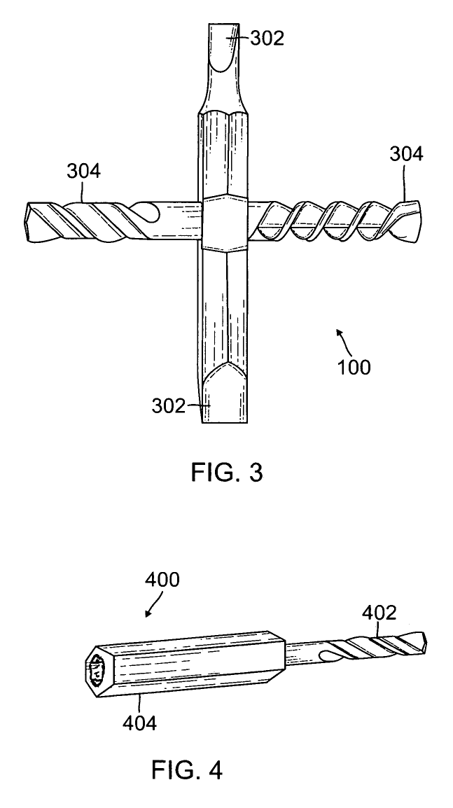

Though the device is illustrated in the figures as including two Philips® and two flat head screwdriver heads of different sizes, the device may include any combination of different bit heads which may be drill and/or screw driver heads of various sizes and/or functionality (e.g. Twist, Spade, Spur, Torx, etc.). According to a preferred embodiment, shown in FIG. 3, the device 100 combines drill 302 and screw driver heads 304 in one unit, which provide convenience to a user in completing a job requiring drilling and the use of a screw driver.

FIG. 4 illustrates an extender 400 for the device 100 which fits over any one of the bit pieces. The extender provides additional bit heads for additional functionality and compactness. The extender includes a bit head 402, which, like the bit heads of the device 100, may be of any size and functionality, and a hexagonal hollow sleeve base 404 which fits over any one of the hexagonal bases 110, 112, 114, and 116, to provide a frictional hold which prevents rotation and slippage of the extender with respect to the tool while in use.

The device 100 may include a multiple number of extenders for each of the bit pieces 101, 103, 105, and 107. However, it is preferable to leave at least one, and more preferably two bit pieces exposed, which would allow for all of the extenders to be held on the device, while one of the bit heads is used. Additionally, the device may include a kit comprising any number of extender pieces that can be interchanged.

Additionally, although the device 100 is illustrated as including four bit pieces, it may practically include any number of bit pieces. Preferably each piece has an opposite radially extending counter piece, forming opposite radial pairs, such that when the base of one piece it held in the too, the bit head of the opposite piece is in parallel alignment with the tool and ready for use. Additionally, although a symmetrical configuration is preferred, it is not necessary.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the description is illustrative and not meant to be a limitation thereof.

What is claimed:

1. A multiple bit device for a tool including a drill or screwdriver comprising:
first and second bit pieces, each comprising a screw driver bit head supported on a hexagonal base;
third and fourth bit pieces, each comprising a drill bit head supported on a hexagonal base, wherein
the base of each of said bit pieces is slidable into a holding element in said tool, said holding element having a hexagonal configuration conforming to the configuration of said bases for providing a frictional hold on said base and preventing rotation of the device in said tool,
said bit pieces radially extending from a common center, such that when said base of one bit is held in said tool, a bit head of another bit can be used, and wherein
said first and second bit pieces extend opposingly from said center, and said third and fourth bit pieces extend opposingly from said center, there being a 90° angle between adjacent bit pieces; and
at least one extender which fits over at least one of said bit pieces, said extender comprising:
a bit head, and
a hollow sleeve supporting said bit head, said sleeve having a hexagonal configuration conforming to the configuration of said bases and sized for insertion over said base of any one of said bit pieces, such that when said sleeve is inserted over one of said bit pieces, said extender is held in place for operational use of said tool.

2. A multiple bit device for a tool including a drill or screwdriver comprising:
four bit pieces, each of said bit pieces comprising:
a bit head, and
a base having a first polygonal configuration in at least a portion thereof, said base being slidable into a holding element in said tool, said holding element having a polygonal configuration conforming to said first polygonal configuration of said base for providing a frictional hold on said base and preventing rotation of the device in said tool,
said bit pieces extending radially and symmetrically from a common center, there being a angle of approximately 90° between adjacent bit pieces and said bit pieces forming opposing pairs about said center, such that when said base of one bit is held in said tool, a bit head of another opposing bit can be used; and
at least one extender which fits over at least one of said bit pieces, said extender comprising:
a bit head, and
a sleeve supporting said bit head, said sleeve having a polygonal configuration conforming to said first polygonal configuration and adapted for insertion over said base of any one of said bit pieces, such that when said sleeve is inserted over one of said bit pieces, said extender is held in place for operational use of said tool.

3. A multiple bit device for a tool including a drill or screwdriver comprising:
four bit pieces comprising:
first and second opposing bit pieces, supported on a hexagonal base; and
third and fourth opposing bit pieces, supported on a hexagonal base,
wherein
each of said bit pieces comprises a screw driver bit head or a drill bit head, said four bit pieces including at least one screw driver bit head and at least one drill bit head, and wherein
the base of each of said bit pieces is slidable into a holding element in said tool, said holding element having a hexagonal configuration conforming to the configuration of said bases for providing a frictional hold on said base and preventing rotation of the device in said tool,
said bit pieces extend from a common center, there being approximately a 90° angle between adjacent bit pieces, and a 180° angle between opposing bit pieces, such that when said base of one bit is held in said tool, a bit head of the opposing bit can be used.

4. A multiple bit device for a tool including a drill or screwdriver comprising:
a plurality of bit pieces, each of said bit pieces comprising:
a bit head comprising either a screw driver head or a drill head, and
a base having a first polygonal configuration in at least a portion thereof, said base being slidable into a holding element in said tool, said holding element having a polygonal configuration conforming to said first polygonal configuration of said base for providing a frictional hold on said base and preventing rotation of the device in said tool,
said bit pieces radially extending from a common center, such that when said base of one bit is held in said tool, a bit head of another bit can be used, and wherein
said plurality of bit pieces includes at least one screw driver bit head and at least one drill bit head.

5. The device of claim 4, further comprising:
at least one extender which fits over at least one of said bit pieces, said extender comprising:
a bit head, and
a hollow sleeve supporting said bit head, said sleeve having a polygonal configuration conforming to said first polygonal configuration and adapted for insertion over said base of any one of said bit pieces, such that when said sleeve is inserted over one of said bit pieces, said extender is held in place for operational use of said tool.

6. The device of claim 5, said extender comprising a bit head including a Philips® head, a flat head, a twist drill head, or combinations thereof.

7. The device of claim 5, comprising a plurality of extenders, wherein the number of extenders is two less than the number of bit pieces.

8. The device of claim 4, said plurality of bit pieces comprising four bit pieces.

9. The device of claim 4, said bit pieces comprising bit heads including a Philips® head, a flat head, a twist drill head, or combinations thereof.

10. The device of claim 4 wherein each of said bit pieces has an opposite radially extending counter piece, such that when the base of one piece is held in the tool, the bit head of the opposite piece can be used.

11. The device of claim 4, said bit pieces having a symmetrical configuration with respect to said center.

12. The device of claim 4, said first polygonal configuration being hexagonal.

13. A multiple bit device for a tool including a drill or screwdriver comprising:
a plurality of bit pieces, each of said bit pieces comprising:
a bit head, and
a base having a first polygonal configuration in at least a portion thereof, said base being slidable into a holding element in said tool, said holding element having a polygonal configuration conforming to said first polygonal configuration of said base for providing a frictional hold on said base and preventing rotation of the device in said tool,
said bit pieces radially extending from a common center, wherein each of said bit pieces has an opposite radially extending counter piece, such that when the base of one piece it held in said tool, the bit head of the opposite piece can be used.

14. The device of claim 13, comprising four bit pieces.

15. The device of claim 13, said bit pieces comprising bit heads including a Philips® head, a flat head, a twist drill head, or combinations thereof.

16. The device of claim 13, said bit pieces being having a symmetrical configuration with respect to said center.

17. An extender bit for a tool comprising at least one bit piece, said bit piece including a hexagonal base, said extender bit comprising:
an extender bit head, and
a sleeve supporting said bit head, said sleeve adapted for insertion over said
base of said bit piece, such that when said sleeve is inserted over said bit piece, said extender is held in place for operational use of said tool.

18. The extender of claim 17, said bit tool including at least one removable bit piece.

19. The extender of claim 17, said bit tool including a removable multi bit unit comprising a plurality of bit pieces.

20. The extender of claim 29, said extender adapted to fit over any one of said plurality of bit pieces.

21. The extender of claim 17, said sleeve having a polygonal configuration which conforms to a polygonal configuration of said base.

22. A method of using a tool comprising a drill or screwdriver, said method comprising:
providing a tool having a receiving element adapted for receiving a tool bit;
providing a multiple bit device comprising a plurality of bit pieces including:
first and second opposing bit pieces, each supported on a base having a polygonal configuration;
third and fourth opposing bit pieces, each supported on a base having a polygonal configuration,
said bit pieces each including a bit head selected from a screw driver head, and a drill head, said plurality of bit pieces including at least one screw driver head and at least one bit head, wherein
the base of each of said bit pieces is slidable into said receiving element in said tool, said receiving element having a polygonal configuration conforming to the configuration of said base of each of said bit pieces for providing a frictional hold on said base and preventing rotation of the device in said tool,
said bit pieces extend from said center, there being approximately a 90° angle between adjacent bit pieces, and a 180° angle between opposing bit pieces; and
inserting said multiple bit device into said tool by inserting the base of one of said bit pieces into the receiving element of the tool, such that the bit head of the opposing bit can be used.
